(19) United States
(12) Patent Application Publication
(10) Pub. No.: US 2015/0315811 A1
(43) Pub. Date: Nov. 5, 2015

(54) HANDLE MODULE

(71) Applicant: Wistron Corporation, New Taipei City (TW)

(72) Inventors: Zhong-Hui Mao, New Taipei City (TW); Shan-Gen Du, New Taipei City (TW); Zhi-Peng Zou, New Taipei City (TW)

(21) Appl. No.: 14/312,704

(22) Filed: Jun. 24, 2014

(30) Foreign Application Priority Data
May 5, 2014 (CN) 201410188554.9

(51) Int. Cl. E05B 5/00

(52) U.S. Cl. CPC E05B 5/00

(57) ABSTRACT

A handle module adapted to a chassis is provided. The chassis includes a main body and a cover. The handle module includes a base, a handle, a sliding component and a linking rod. The base is disposed on the cover. The handle is pivoted to the base. The sliding component is connected to the main body and is slidably disposed on the base. Two ends of the linking rod are pivoted to the handle and the sliding component respectively. When the handle closed to the base is rotated relative to the base to be expanded from the base, the handle pulls the sliding component to slide relative to the base along a first axis by the linking rod, so as to drive the cover to move from a first position to a second position relative to the main body along the first axis.

### CROSS-REFERENCE TO RELATED APPLICATION

This application claims the priority benefit of China application serial no. 201410188554.9, filed on May 5, 2014. The entirety of the above-mentioned patent application is hereby incorporated by reference herein and made a part of this specification.

### BACKGROUND

1. Field of the Invention

The invention relates to a handle module, and more particularly, to a handle module adapted to a server.

2. Description of Related Art

A server is a core computer which serves all the computers or portable electronic apparatuses in a network system and provides network users with discs and functions such as printing, etc. Also, the server allows the users to share resources in the network. The basic frame of the server is approximately the same as that of an ordinary personal computer, consisting of members such as a central processing unit (CPU), a memory, input/output (I/O) equipment, etc. Generally, a cover is used to cover the members in a chassis of the server. In most cases, the cover is designed to move relative to a main body of the chassis by pushing or pulling a handle or the like, so as to release an engagement relationship between the cover and the main body of the chassis to enable the cover to be opened.

FIG. 1 illustrates a conventional handle module. As shown in FIG. 1, a conventional handle module 50 includes a handle 52, a sliding buckle plate 54 and a stationary support 56. The stationary support 56 is fixed to a cover 60. The sliding buckle plate 54 is disposed in the stationary support 56 and adapted to be connected to a main body of a chassis. A handle rotation axis 52b is pivoted into a rotation axis hole 56a of the stationary support 56. A pin axis 52a is fixed to the handle 52 and disposed in a sliding slot 54a of the sliding buckle plate 54. The sliding slot 54a extends along a vertical direction V. When the handle 52 is rotated around the rotation axis 52b due to a force applied by a user and is expanded as illustrated in the drawing, the pin axis 52a produces a displacement relative to the cover 60 in a horizontal direction H. By the pin axis 52a pushing an inner wall of the sliding slot 54a, the sliding buckle plate 54 is driven to move relative to the cover 60 along the horizontal direction H. Consequently, the cover 60 moves relative to the main body of the chassis connected to the sliding buckle plate 54 along a horizontal direction H′. With the above arrangement and operating manner of the conventional handle module 50, during operation, the pin axis 52a not only produces a displacement in the horizontal direction H, but also produces a displacement in the vertical direction V. Accordingly, the main body of the chassis is required to contain the sliding slot 54a for the pin axis 52a to move through, and part of the arrangement space in the main body of the chassis is thereby occupied. In addition, in order to prevent the sliding slot 54a from occupying too much space in the main body of the chassis, the length of the sliding slot 54a along the vertical direction V is limited. As a result, the handle module 50 and the cover 60 are not allowed to have a larger operating path in the horizontal direction H.

### SUMMARY OF THE INVENTION

The invention provides a handle module that saves the arrangement space in a chassis and has a larger operating path.

The handle module of the invention is adapted to a chassis. The chassis includes a main body and a cover. The handle module includes a base, a handle, a sliding component and a linking rod. The base is disposed on the cover. The handle is pivoted to the base. The sliding component is connected to the main body and is slidably disposed on the base. Two ends of the linking rod are pivoted to the handle and the sliding component respectively. When the handle closed to the base is rotated relative to the base to be expanded from the base, the handle pulls the sliding component to slide relative to the base along a first axis by the linking rod, so as to drive the cover to move from a first position to a second position relative to the main body along the first axis.

In an embodiment of the invention, the first axis is parallel to an extension direction of the cover and perpendicular to a depth direction of the main body.

In an embodiment of the invention, when the cover is located at the first position, the cover is limited by the main body to be unable to move away from the main body along a second axis perpendicular to the first axis, and when the cover is located at the second position, the cover is released from the main body.

In an embodiment of the invention, when the handle expanded from the base is rotated relative to the base to be closed to the base, the handle pushes the sliding component to slide relative to the base along the first axis by the linking rod, so as to drive the cover to move from the second position to the first position relative to the main body along the first axis.

In an embodiment of the invention, the main body of the chassis has a pillar and the sliding component has an opening. The pillar is inserted into the opening to prohibit the sliding component and the main body from moving relatively along the first axis.

In an embodiment of the invention, the handle module further includes a pressing component, wherein the pressing component is disposed on the handle. When the handle is closed to the base, the pressing component is limited to the base so as to prevent the handle from being expanded from the base. When the pressing component is pressed to be released from the base, the handle is adapted to be expanded from the base.

In an embodiment of the invention, the pressing component has an elastic arm and at least one hook. The elastic abuts against the hook. The base has at least one projection. When the handle is closed to the base, the hook is hooked onto the projection so as to limit the pressing component to the base. When the pressing component is pressed, the hook is released from the projection due to an elastic deformation of the elastic arm.

In an embodiment of the invention, the pressing component is adapted to be pressed along a first direction so as to be released from the base, and the cover is adapted to move from the first position to the second position relative to the main body along a second direction, wherein the first direction and the second direction are opposite to each other and parallel to the first axis.

In an embodiment of the invention, the handle is adapted to receive a force along a first direction so as to be expanded from the base, and the cover is adapted to move from the first position to the second position relative to the main body along a second direction, wherein the first direction and the second direction are opposite to each other and parallel to the first axis.

In an embodiment of the invention, the handle module further includes an elastic component, wherein the handle is adapted to receive a force along a first direction so as to be expanded from the base. The elastic component is connected between the base and the sliding component. The sliding component is adapted to slide relative to the base along the first direction by an elastic force of the elastic component, wherein the first direction is parallel to the first axis.

In an embodiment of the invention, the handle has a free end, a first pivot portion and a second pivot portion. The second pivot portion is located between the free end and the first pivot portion. The handle is pivoted to the base via the first pivot portion. The linking rod is pivoted to the second pivot portion.

In an embodiment of the invention, when the handle is expanded from the base, the second pivot portion moves with the handle along a direction departing from the chassis.

In an embodiment of the invention, a distance between the free end and the first pivot portion is greater than a distance between the second pivot portion and the first pivot portion.

In an embodiment of the invention, the base has at least one sliding slot. The sliding component has at least one sliding pin. The sliding pin is slidably disposed in the sliding slot along the first axis. When an expansion angle between the handle and the base is increased with an expansion of the handle to reach a predetermined value, the sliding pin abuts against an end of the sliding slot to prevent a continued increase in the expansion angle between the handle and the base.

Based on the above, during the operation of the handle module of the invention, a sliding axis of the sliding component is the same as a moving axis (i.e. the above first axis) of the cover. Namely, a sliding direction of the sliding component is parallel to a moving direction of the cover, such that the sliding component produces no displacement in the depth direction of the main body of the chassis. Accordingly, it is not necessary to reserve the space in the main body of the chassis for operation of the sliding component, and thus the arrangement space in the chassis is saved. In addition, since the sliding component produces no displacement in the depth direction of the main body of the chassis, it is not necessary to limit a sliding path of the sliding component for the purpose of preventing the handle module from occupying too much space in the chassis. In this way, the cover driven by the sliding component may have a relatively sufficient moving path, so as to fulfill design requirements.

To make the above features and advantages of the invention more comprehensible, embodiments accompanied with drawings are described in detail as follows.

### BRIEF DESCRIPTION OF THE DRAWINGS

FIG. 1 illustrates a conventional handle module.

FIG. 2 is a three-dimensional view of application of a handle module to a server according to an embodiment of the invention.

FIG. 3 illustrates the handle module in FIG. 2 driving operation of a cover.

FIG. 4 is an enlarged view of the region R1 of the chassis in FIG. 2.

FIG. 5 is an enlarged view of the region R1′ of the chassis in FIG. 3.

FIG. 6 is an enlarged view of the region R2 of the chassis in FIG. 2.

FIG. 7 is an enlarged view of the region R2′ of the chassis in FIG. 3.

FIG. 8 illustrates a pillar of the main body of the chassis in FIG. 2.

FIG. 9 is a three-dimensional view of the handle in FIG. 6 from another view angle.

FIG. 10 is a three-dimensional view of the base in FIG. 6.

FIG. 11 is a three-dimensional view of the pressing component in FIG. 6.

FIG. 12 illustrates a partial structure of the handle module and the cover in FIG. 6.

FIG. 13 illustrates the handle in FIG. 6 being expanded by an elastic force of an elastic component.

FIG. 14 is a three-dimensional view of the sliding component in FIG. 7 from another view angle.

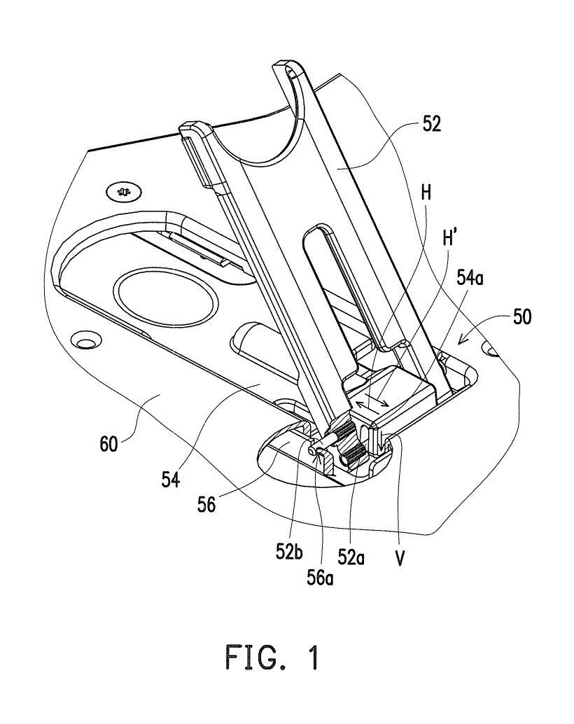

### DETAILED DESCRIPTION OF DISCLOSED EMBODIMENTS

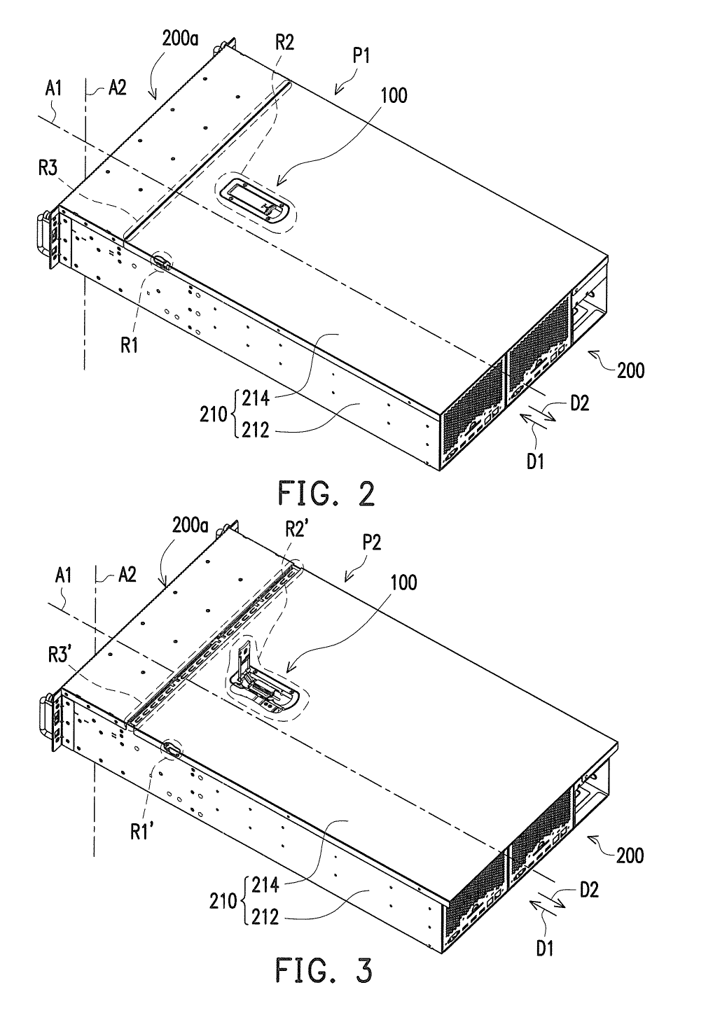

FIG. 2 is a three-dimensional view of application of a handle module to a server according to an embodiment of the invention. FIG. 3 illustrates the handle module in FIG. 2 driving operation of a cover. Referring to FIG. 2 and FIG. 3, a handle module 100 of the present embodiment is applied to a chassis 210 of a server 200. The chassis 210 includes a main body 212 and a cover 214, and the cover 214 is configured to cover members disposed in the main body 212. The handle module 100 is installed on the cover 214, and is configured to drive the cover 214 to move from a first position P1 shown in FIG. 2 to a second position P2 shown in FIG. 3 along a first axis A1, so as to release an engagement relationship between the cover 214 and the main body 212 to enable the cover 214 to be opened. In other embodiments, the handle module 100 may be applied to chassis of other kinds of apparatuses, and the invention is not thereby limited.

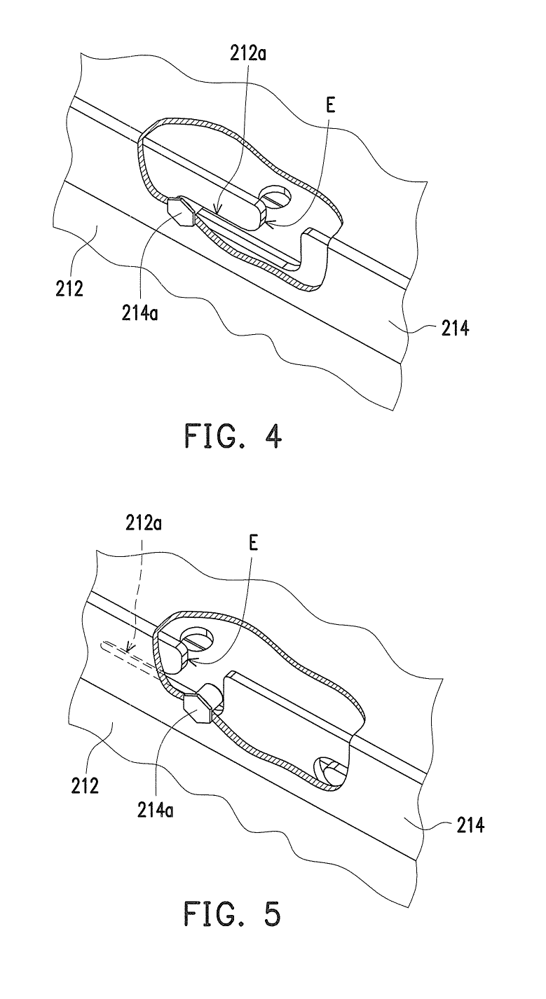

FIG. 4 is an enlarged view of the region R1 of the chassis in FIG. 2. FIG. 5 is an enlarged view of the region R1′ of the chassis in FIG. 3. Referring to FIG. 4 and FIG. 5, specifically, the main body 212 has a position limiting slot 212a, and the cover 214 has a position limiting post 214a. When the cover 214 is located at the position P1 shown in FIG. 2, the position limiting post 214a of the cover 214 is located in the position limiting slot 212a of the main body 212, as shown in FIG. 4. By the engagement relationship between the position limiting post 214a and the position limiting slot 212a, the cover 214 is prevented from moving away from the main body 212 along a second axis A2 (illustrated in FIG. 2 and FIG. 3) perpendicular to the first axis A1. When the cover 214 moves from the first position P1 shown in FIG. 2 to the second position P2 shown in FIG. 3, the position limiting post 214a moves with the cover 214 along the first axis A1 to be disengaged from the position limiting slot 212a of the main body 212, as shown in FIG. 5, thereby releasing the engagement relationship. The first axis A1 is parallel to an extension direction of the cover 214 and is perpendicular to a depth direction of the main body 212. The second axis A2 is perpendicular to an extension direction of the cover 214 and is parallel to a depth direction of the main body 212.

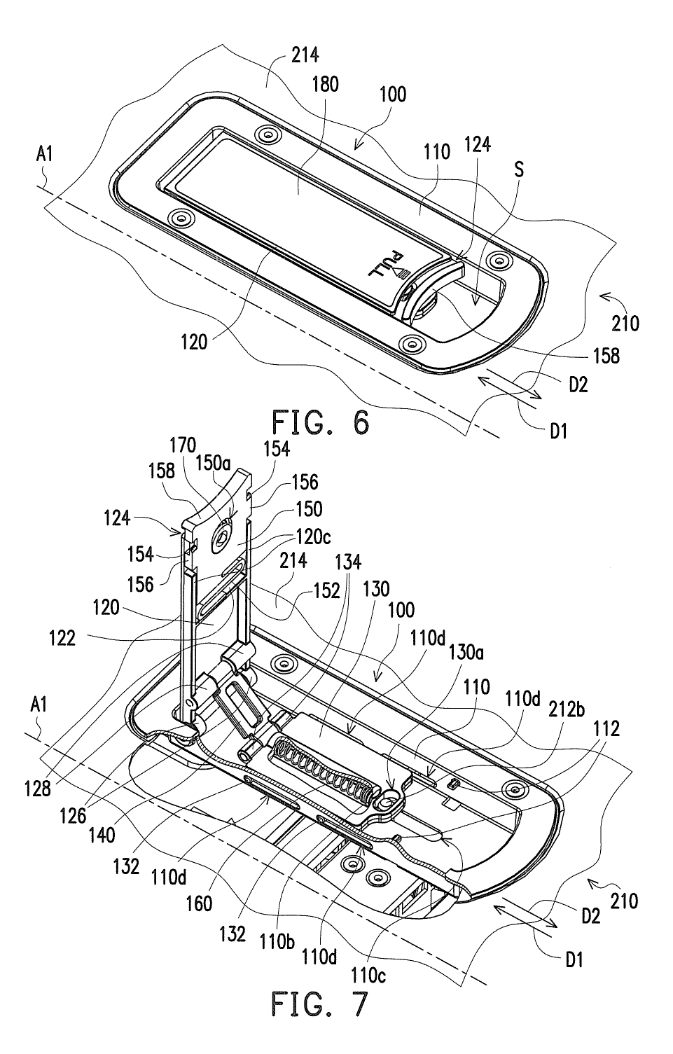

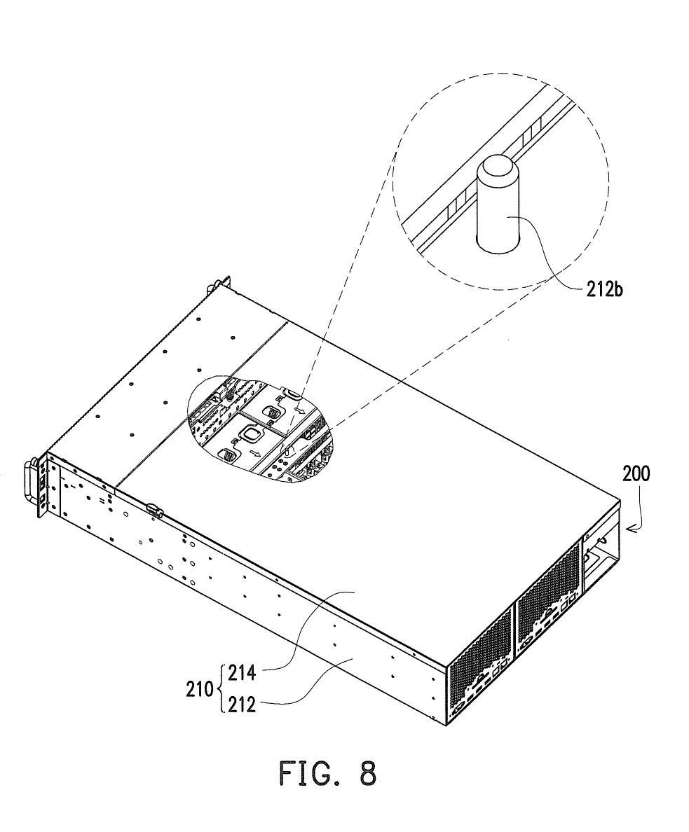

An operating manner of the handle module 100 of the present embodiment is hereinafter described in detail. FIG. 6 is an enlarged view of the region R2 of the chassis in FIG. 2. FIG. 7 is an enlarged view of the region R2′ of the chassis in FIG. 3. FIG. 8 illustrates a pillar of the main body of the chassis in FIG. 2. Referring to FIG. 6 to FIG. 8, the handle module 100 of the present embodiment includes a base 110, a handle 120, a sliding component 130 and a linking rod 140. The base 110 is disposed on the cover 214 by, for example, fixing with rivets. The handle 120 is pivoted to the base 110. The main body 212 of the chassis 210 has a pillar 212b. The sliding component 130 is slidably disposed on the base 110 along the first axis A1, and has an opening 130a. The base 110 has an open slot 110c. The pillar 212b of the main body 212 passes through the open slot 110c of the base 110 and is inserted into the opening 130a of the sliding component 130, thereby connecting the sliding component 130 to the main body 212, and also prohibiting the sliding component 130 and the main body 212 from moving relatively along the first axis A1. Two ends of the linking rod 140 are pivoted to the handle 120 and the sliding component 130 respectively.

Since the base 110 and the cover 214 are fixed to each other and unable to move relative to each other, and as mentioned above, the sliding component 130 and the main body 212 are prohibited from moving relatively along the first axis A1 due to combination of the opening 130a with the pillar 212b, when the sliding component 130 slides relative to the base 110 along the first axis A1, the relative positions of the cover 214 and the main body 212 are changed in accordance with the sliding motion of the sliding component 130.

Following the above, when a user intends to open the cover 214 shown in FIG. 2, he/she opens the handle 120 that was closed to the base 110 as shown in FIG. 6, causing the handle 120 to rotate relative to the base 110 to be expanded from the base 110, as shown in FIG. 7. In this process, by means of the linking rod 140, the handle 120 pulls the sliding component 130 to slide relative to the base 110 along a first direction D1 parallel to the first axis A1, so as to drive the cover 214 to move from the first position P1 to the second position P2 relative to the main body 212 along a second direction D2 parallel to the first axis A1, as shown in FIG. 2 to FIG. 3, wherein the first direction D1 and the second direction D2 are opposite to each other. When intending to close the cover 214 shown in FIG. 3, the user applies a force to the handle 120 expanded from the base 110 as shown in FIG. 7, causing the handle 120 to rotate relative to the base 110 to be closed to the base 110. At this moment, by means of the linking rod 140, the handle 120 pushes the sliding component 130 to slide relative to the base 110 along the second direction D2 parallel to the first axis A1, so as to drive the cover 214 to move from the second position P2 to the first position P1 relative to the main body 212 along the first direction D1 parallel to the first axis A1, as shown in FIG. 3 to FIG. 2.

During the above operation of the handle module 100, a sliding axis of the sliding component 130 is the same as a moving axis (i.e. the above first axis A1) of the cover 214, and that is, a sliding direction of the sliding component 130 is parallel to a moving direction of the cover 214. Based on the above, the sliding component 130 produces no displacement in the depth direction (i.e. the direction parallel to the second axis A2) of the main body 212 of the chassis 210. Hence, it is not necessary to reserve the space in the main body 212 of the chassis 210 for operation of the sliding component 130, and thus the arrangement space in the chassis 210 is saved. Specifically, since the sliding component 130 produces no displacement in the depth direction of the main body 212 of the chassis 210, it is not necessary to limit a sliding path of the sliding component 130 for the purpose of preventing the handle module 100 from occupying too much space in the chassis 210. In this way, the cover 214 driven by the sliding component 130 may have a relatively sufficient moving path, so as to fulfill design requirements. For example, since the cover 214 of the present embodiment has a relatively sufficient moving path as mentioned above, when the cover 214 is located at the first position P1 as shown in FIG. 2, a larger overlap area is formed at the junction (e.g. a region R3 in FIG. 2 and a region R3′ in FIG. 3) of the cover 214 and the main body 212, thereby effectively preventing a leakage of electromagnetic waves from the chassis 210.

Referring to FIG. 6 and FIG. 7, the handle module 100 of the present embodiment further includes a pressing component 150, and the pressing component 150 is disposed on the handle 120. When the handle 120 is closed to the base 110 as shown in FIG. 6, the pressing component 150 is limited to the base 110 so as to prevent the handle 120 from being expanded from the base 110. When the user presses the pressing component 150 to cause an elastic deformation thereon such that the pressing component 150 is released from the base 110, the handle 120 is expanded from the base 110 as shown in FIG. 7.

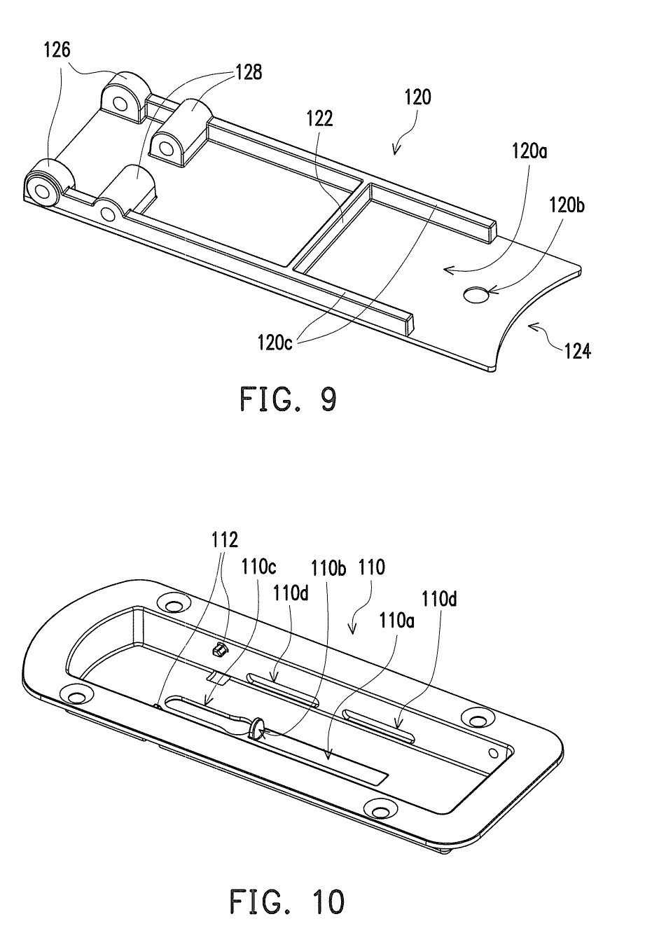

The function relationships between the base 110, the handle 120 and the pressing component 150 are hereinafter described in detail. FIG. 9 is a three-dimensional view of the handle in FIG. 6 from another view angle. FIG. 10 is a three-dimensional view of the base in FIG. 6. FIG. 11 is a three-dimensional view of the pressing component in FIG. 6. In the present embodiment, the handle 120 is, for example, an integrally formed metal component, and has a containing space 120a, an abutting portion 122, two position limiting ribs 120c and a riveting hole 120b, as shown in FIG. 9. The base 110 is, for example, an integrally formed metal component, and has two projections 112, as shown in FIG. 7 and FIG. 10. The pressing component 150 is, for example, an integrally formed plastic component, and has an elastic arm 152, two hooks 154, two stopping portions 156, a sliding hole 150a and a pressing portion 158, as shown in FIG. 7 and FIG. 11. A riveting post 170 shown in FIG. 7 passes through the sliding hole 150a of the pressing component 150 to be riveted into the riveting hole 120b of the handle 120, and also prevents the pressing component 150 being separated from the handle 120. Consequently, the pressing component 150 is located in the containing space 120a of the handle 120 and limited between the two position limiting ribs 120c. Moreover, the elastic arm 152 of the pressing component 150 abuts against the abutting portion 122 of the handle 120. The sliding hole 150a of the pressing component 150 is, for example, an elliptic hole, and has a major axis longer than an outer diameter of the riveting post 170 and parallel to a pressing direction of the pressing component 150, such that the pressing component 150 smoothly operates when pressed. In addition, an appearance 180 (such as a sticker) is disposed on the handle 120 to cover the riveting hole 120b and the riveting post 170, so as to provide the handle 120 with a better appearance. Moreover, the user may be given operating instructions through the words or graphics on the appearance 180.

When the handle 120 is closed to the base 110 as shown in FIG. 6, each of the hooks 154 (illustrated in FIG. 7) of the pressing component 150 is hooked onto the corresponding projection 112 (illustrated in FIG. 7) of the base 110, so as to limit the pressing component 150 to the base 110. When the user inserts his/her finger into an operation space S of the base 110 shown in FIG. 6 to press the pressing portion 158 of the pressing component 150 along the first direction D1, each of the hooks 154 of the pressing component 150 is released from the corresponding projection 112 of the base 110 due to the elastic deformation of the elastic arm 152. Consequently, the pressing component 150 and the handle 120 are released from the base 110. During the user's pressing operation on the pressing component 150, by a contact between the stopping portions 156 of the pressing component 150 and ends of the position limiting ribs 120c of the handle 120, a pressing path of the pressing component 150 is limited. When the user stops pressing the pressing component 150, the pressing component 150 is restored by an elastic force of the elastic arm 152. In addition, each of the hooks 154 of the present embodiment has a guiding inclined plane 154a, and by guidance of the guiding inclined plane 154a, each of the hooks 154 is smoothly hooked onto the corresponding projection 112 when the handle 120 is closed to the base 110.

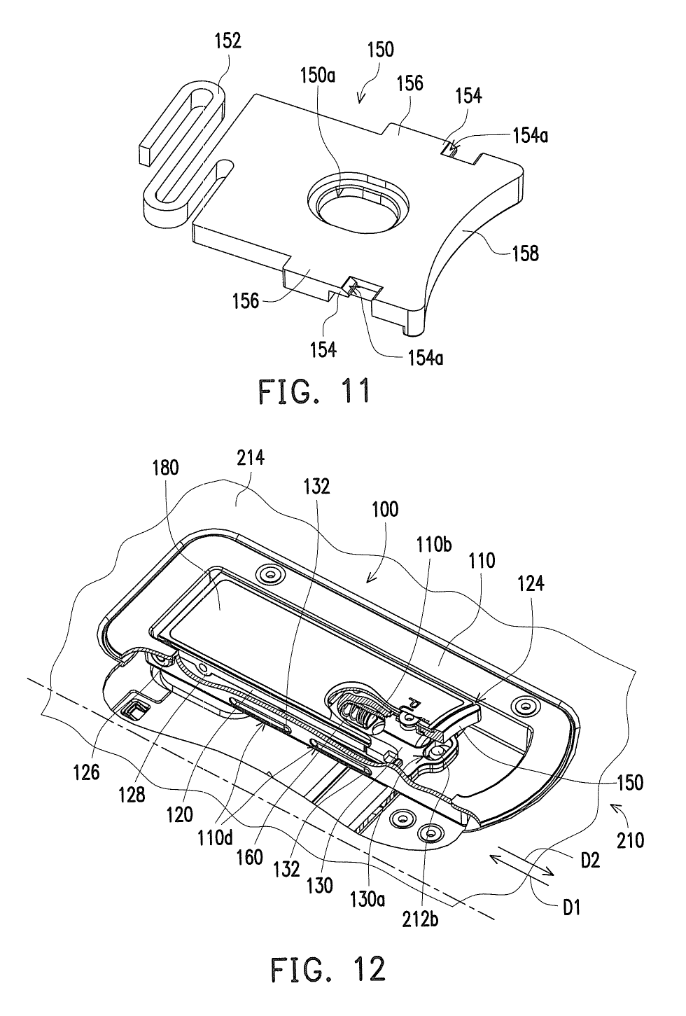

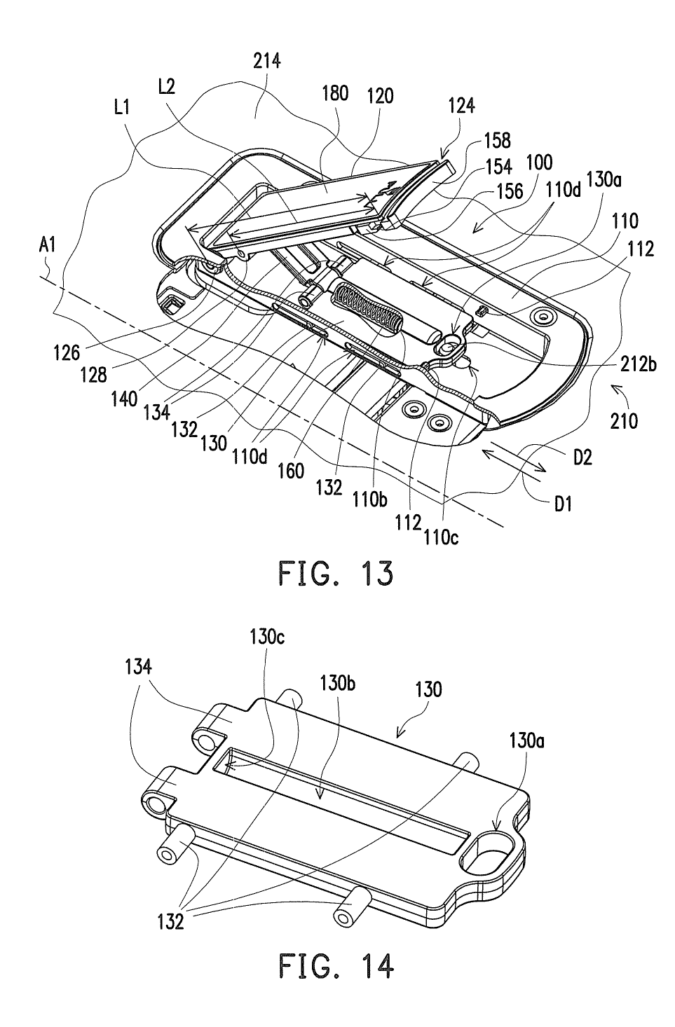

FIG. 12 illustrates a partial structure of the handle module and the cover in FIG. 6. FIG. 13 illustrates the handle in FIG. 6 being expanded by an elastic force of an elastic component. Referring to FIG. 7, FIG. 12 and FIG. 13, the handle module 100 of the present embodiment further includes an elastic component 160. The elastic component 160 is, for example, a compression spring, and is connected between the base 110 and the sliding component 130. When the handle 120 is closed to the base 110 as shown in FIG. 6 and FIG. 12, the elastic component 160 stores an elastic potential energy. When the pressing component 150 and the handle 120 are released from the base 110 as mentioned above, the elastic component 160 releases the elastic potential energy, and by the elastic force of the elastic component 160, the sliding component 130 slides relative to the base 110 along the first direction D1, such that the handle 120 is lifted automatically as shown in FIG. 13. Next, the user continues to apply a force to the handle 120 along the first direction D1, such that the handle 120 is expanded to the state shown in FIG. 7, thereby driving the cover 214 to move to the second position P2 shown in FIG. 3. By the above operating manner of the elastic component 160, simply by pressing the pressing component 150, the user is able to make the handle 120 lifted automatically for the convenience of subsequent operations.

FIG. 14 is a three-dimensional view of the sliding component in FIG. 7 from another view angle. Referring to FIG. 10 and FIG. 14, in the present embodiment, the base 110, for example, has a plurality of sliding slots 110d, and the sliding component 130 has a plurality of sliding pins 132. Each of the sliding pins 132 is slidably disposed in the corresponding sliding slot 110d along the first axis A1, as shown in FIG. 7, FIG. 12 and FIG. 13. When an expansion angle between the handle 120 and the base 110 is increased with the expansion of the handle 120 to reach a predetermined value (e.g. 90 degrees, as illustrated in FIG. 7), each of the sliding pins 132 abuts against an end of the corresponding sliding slot 110d to prevent a continued increase in the expansion angle between the handle 120 and the base 110, such that the handle module 100 is maintained in the opened state shown in FIG. 7.

Following the above, when the user turns over the handle 120 to render it in the state shown in FIG. 7, and separates the cover 214 from the main body 212, the elastic component 160 is capable of positioning the sliding component 130 and the handle 120 to the positions shown in FIG. 7, such that the handle module 100 is maintained in the opened state. Based on the above, when the user again installs the cover 214 onto the main body 212 to align the position limiting post 214a of the cover 214 with an opening end E (illustrated in FIG. 4 and FIG. 5) of the position limiting slot 212a of the main body 212, it is ensured that the opening 130a of the sliding component 130 is aligned with the pillar 212b of the main body 212 for smooth installation of the cover 214. After the position limiting post 214a of the cover 214 enters the opening end E of the position limiting slot 212a, and the pillar 212b of the main body 212 is inserted into the opening 130a of the sliding component 130, the user applies a force to the handle 120 shown in FIG. 7 to cause it to be closed to the base 110 as shown in FIG. 6, so as to drive the cover 214 to move to the first position P1 shown in FIG. 2. Consequently, the cover 214 is engaged with the main body 212 by an interference of the position limiting post 214a and the position limiting slot 212a of the main body 212.

In the present embodiment, as shown in FIG. 14, the sliding component 130 has a containing space 1301) and an abutting portion 130c; as shown in FIG. 10, the base 110 has a containing space 110a and an abutting portion 110b. The containing space 130b of the sliding component 130 and the containing space 110a of the base 110 are configured to contain the elastic component 160 shown in FIG. 7, and two ends of the elastic component 160 respectively abut against the abutting portion 130c of the sliding component 130 and the abutting portion 110b of the base 110. Consequently, the elastic component 160 is compressed with the relative movement of the sliding component 130 and the base 110, and the sliding component 130 is pushed by the elastic force of the elastic component 160.

In the present embodiment, the user, for example, operates the handle module 100 from a front side 200a of the server 200 shown in FIG. 2 and FIG. 3. In the above operating manner of the handle module 100, when the user located at the front side 200a of the server 200 intends to open the cover 214, he/she presses the pressing component 150 toward his/her own direction (i.e. the first direction D1) to release the pressing component 150 and the handle 120 from the base 110. Moreover, after the handle 120 is lifted, the user applies a force to the handle 120 toward his/her own direction (i.e. the first direction D1) to cause the handle 120 to continue expanding, thereby driving the cover 214 to move along a direction (i.e. the second direction D2) departing from the user's direction to be opened. In this way, the handle module 100 of the present embodiment is more ergonomic that enables the user to operate in an effort-saving way.

Referring to FIG. 7, FIG. 9 and FIG. 14, the handle 120 of the present embodiment has a free end 124, a first pivot portion 126 and a second pivot portion 128. The sliding component 130 has a fourth pivot portion 134. The handle 120 is pivoted to the base 110 via the first pivot portion 126. The two ends of the linking rod 140 are pivoted to the second pivot portion 128 of the handle 120 and the fourth pivot portion 134 of the sliding component 130 respectively. It is to be noted particularly that the second pivot portion 128 is located between the free end 124 and the first pivot portion 126. With such arrangement, when the handle 120 is expanded from the base 110 as shown in FIG. 7, the second pivot portion 128 moves with the handle 120 along a direction departing from the chassis 210, such that the linking rod 140 is turned over upward instead of downward. Accordingly, the linking rod 140 does not move inward into the chassis 210 during operation, and it is hence not necessary to reserve a space in the chassis 210 for operation of the linking rod 140. Thus, the arrangement space in the chassis 210 is saved.

In addition, in the handle 120 of the present embodiment, since the second pivot portion 128 is located between the free end 124 and the first pivot portion 126 as mentioned above, a distance L1 between the free end 124 and the first pivot portion 126 is greater than a distance L2 between the second pivot portion 128 and the first pivot portion 126, as shown in FIG. 13. The user applies a force to the free end 124 of the handle 120 to drive operation of the linking rod 140 connected to the second pivot portion 128. In this force applying process, since a lever arm (equivalent to the above distance L1) between the free end 124 and the first pivot portion 126 is greater than a lever arm (equivalent to the above distance L2) between the second pivot portion 128 and the first pivot portion 126, an effort-saving effect may be achieved.

In summary, during the operation of the handle module of the invention, the sliding axis of the sliding component is the same as the moving axis (i.e. the first axis) of the cover. Namely, the sliding direction of the sliding component is parallel to the moving direction of the cover, such that the sliding component produces no displacement in the depth direction of the main body of the chassis. Moreover, the linking rod does not move inward into the chassis during operation. Accordingly, it is not necessary to reserve the space in the main body of the chassis for operation of the sliding component and the linking rod, and thus the arrangement space in the chassis is saved. In addition, since the sliding component produces no displacement in the depth direction of the main body of the chassis, and the linking rod does not move inward into the chassis during operation, it is not necessary to limit the sliding path of the sliding component and the overturn range of the linking rod for the purpose of preventing the handle module from occupying too much space in the chassis. In this way, the cover driven by the sliding component may have a relatively sufficient moving path, and further, a larger overlap area is formed at the junction of the cover and the main body of the chassis, thereby effectively preventing a leakage of electromagnetic waves from the chassis.

Although the invention has been described with reference to the above embodiments, it will be apparent to persons of ordinary skill in the art that modifications to the described embodiments may be made without departing from the spirit of the invention. Accordingly, the scope of the invention will be defined by the attached claims and not by the above detailed descriptions.

What is claimed is:

1. A handle module adapted to a chassis, the chassis comprising a main body and a cover, the handle module comprising:
a base, disposed on the cover;
a handle, pivoted to the base;
a sliding component, connected to the main body and slidably disposed on the base; and
a linking rod, two ends of the linking rod being pivoted to the handle and the sliding component respectively,
wherein when the handle closed to the base is rotated relative to the base to be expanded from the base, the handle pulls the sliding component to slide relative to the base along a first axis by the linking rod, so as to drive the cover to move from a first position to a second position relative to the main body along the first axis.

2. The handle module of claim 1, wherein the first axis is parallel to an extension direction of the cover and perpendicular to a depth direction of the main body.

3. The handle module of claim 1, wherein when the cover is located at the first position, the cover is limited by the main body to be unable to move away from the main body along a second axis perpendicular to the first axis, and when the cover is located at the second position, the cover is released from the main body.

4. The handle module of claim 1, wherein when the handle expanded from the base is rotated relative to the base to be closed to the base, the handle pushes the sliding component to slide relative to the base along the first axis by the linking rod, so as to drive the cover to move from the second position to the first position relative to the main body along the first axis.

5. The handle module of claim 1, wherein the main body of the chassis has a pillar and the sliding component has an opening, the pillar being inserted into the opening to prohibit the sliding component and the main body from moving relatively along the first axis.

6. The handle module of claim 1, further comprising a pressing component, wherein the pressing component is disposed on the handle, when the handle is closed to the base, the pressing component is limited to the base so as to prevent the handle from being expanded from the base, and when the pressing component is pressed to be released from the base, the handle is adapted to be expanded from the base.

7. The handle module of claim 6, wherein the pressing component has an elastic arm and at least one hook, the elastic abuts against the hook, the base has at least one projection, when the handle is closed to the base, the hook is hooked onto the projection so as to limit the pressing component to the base, and when the pressing component is pressed, the hook is released from the projection due to an elastic deformation of the elastic arm.

8. The handle module of claim 6, wherein the pressing component is adapted to be pressed along a first direction so as to be released from the base, and the cover is adapted to move from the first position to the second position relative to the main body along a second direction, wherein the first direction and the second direction are opposite to each other and parallel to the first axis.

9. The handle module of claim 1, wherein the handle is adapted to receive a force along a first direction so as to be expanded from the base, and the cover is adapted to move from the first position to the second position relative to the main body along a second direction, wherein the first direction and the second direction are opposite to each other and parallel to the first axis.

10. The handle module of claim 1, further comprising an elastic component, wherein the handle is adapted to receive a force along a first direction so as to be expanded from the base, the elastic component is connected between the base and the sliding component, the sliding component is adapted to slide relative to the base along the first direction by an elastic force of the elastic component, wherein the first direction is parallel to the first axis.

11. The handle module of claim 1, wherein the handle has a free end, a first pivot portion and a second pivot portion, the second pivot portion is located between the free end and the first pivot portion, the handle is pivoted to the base via the first pivot portion, and the linking rod is pivoted to the second pivot portion.

12. The handle module of claim 11, wherein when the handle is expanded from the base, the second pivot portion moves with the handle along a direction departing from the chassis.

13. The handle module of claim 11, wherein a distance between the free end and the first pivot portion is greater than a distance between the second pivot portion and the first pivot portion.

14. The handle module of claim 1, wherein the base has at least one sliding slot, the sliding component has at least one sliding pin, the sliding pin is slidably disposed in the sliding slot along the first axis, and when an expansion angle between the handle and the base is increased with an expansion of the handle to reach a predetermined value, the sliding pin abuts against an end of the sliding slot to prevent a continued increase in the expansion angle between the handle and the base.
